(19) United States
(12) Patent Application Publication
(10) Pub. No.: US 2008/0126214 A1
(43) Pub. Date: May 29, 2008

(54) Ordering supplies from an operator control panel of storage apparatus

(76) Inventors: Curtis C. Ballard, Eaton, CO (US); Kelly J. Reasoner, Fort Collins, CO (US); Stanley S. Feather, Longmont, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/259,225

(22) Filed: Oct. 26, 2005

(51) Int. Cl. G06Q 30/00; G06F 19/00

(52) U.S. Cl. 705/26; 700/216

(57) ABSTRACT

Storage apparatus and methods that allow direct ordering of storage supplies from a vendor. Exemplary storage apparatus comprises a housing, and a controller contained within the housing that is configured to robotically manage removable media. A communications module is coupled to the controller for communicating with the vendor. An operator control panel is attached to the housing, is coupled to the controller, and is configurable to allow a user to order storage supplies from the vendor via the communications module. As a result, the storage supplies are ordered directly from the storage apparatus.

### BACKGROUND

Businesses, governmental agencies, learning institutions, and other organizations typically operate computers that are interconnected by a network. Network users often store data on hard drives of network servers. Users also store data on their host computers.

Data stored on the network and/or host computers is typically backed-up periodically to create a copy of the data to prevent it from being lost due to mechanical failure or accidental deletion, for example, and/or to produce an archive of the data. Backup operations typically involve storing a copy of all or a portion of the data files on the network and/or host computers to a backup device such as a magnetic tape library having a plurality of magnetic tape drives.

Digital magnetic tape has long been used for data storage in computer systems. The low cost-per-bit stored, long-term retention capability, and portability of magnetic tape cartridges have made them invaluable for storing large quantities of data generated by businesses.

Tape cartridges are used by automated tape library devices. Tape libraries generally handle many tape cartridges to store very large amounts of data. The tape libraries hold the tape cartridges in predefined positions or media slots. When data is required from a particular tape cartridge, a host system communicates via a Small Computer System Interface (SCSI) bus or a Fibre Channel (FC) fabric, for example, with a controller of the tape library. The controller retrieves the particular tape cartridge from its media slot and places the tape cartridge in a tape drive. The host system may then read from or write to the tape cartridge via the tape drive. Also, the host system may query the controller to determine the number of tape cartridges, tape drives, and robotics mechanisms contained in the tape library to manage the tape library.

There are a number of manufacturers of tape libraries that back up and store large quantities of data to digital magnetic tape cartridges. For example, a StorageWorks brand of tape libraries are manufactured in various sizes and configurations. The number of tape cartridges that can be loaded into such tape libraries varies depending upon model, but may be on the order of 400-500 tapes, for example.

A typical tape library usually has a control and display panel (or operator control panel) where local functions are controlled and where the health of the tape library may be displayed. The display typically presents information about components in the tape library that are built by the original library manufacturer. Value added components may also be installed in the tape library including software tools to aid in the configuration, installation, and management of the tape library.

Tape libraries require specific tapes and barcodes. Hewlett-Packard Company (HP), for example, recommends that only HP tapes be used, and in many libraries requires that the barcode are HP barcodes. The supplies are not easily available at office supply stores and must be ordered from an approved supplier or directly from HP. This process requires a non-standard order for many customers that have standardized ordering processes and involves Internet or telephone ordering. This is not a standard ordering method for most customers and is inconvenient.

It would be desirable to have a backup storage library that provides an interface and prompt for ordering supplies.

### BRIEF DESCRIPTION OF THE DRAWINGS

The various features and advantages of embodiments of the present invention may be more readily understood with reference to the following detailed description taken in conjunction with the accompanying drawings, wherein like reference numerals designate like structural elements, and in which:

FIG. 1 is a block diagram that illustrates an exemplary tape library;

FIG. 2 illustrates how supplies are ordered from an exemplary operator control panel;

FIGS. 3a-3d show exemplary display screens that may be presented on the operator control panel of the exemplary tape library; and

FIG. 4 is a flow diagram that illustrates an exemplary media ordering method for use with backup storage devices.

### DETAILED DESCRIPTION

Backup storage apparatus 10 is disclosed and is discussed below in the context of a magnetic tape library 10. However, it is to be understood that the backup storage apparatus 10 is not limited only to magnetic tape libraries, but may be employed in the context of other storage devices and systems, including optical drives and hard disk drives, for example.

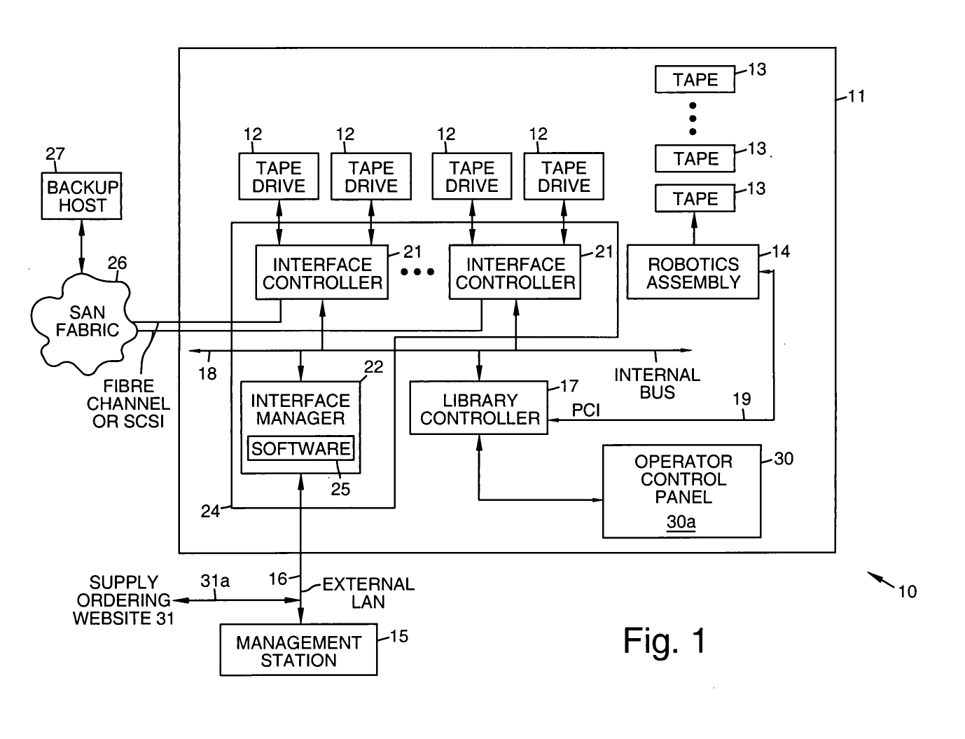

Referring to the drawing figures, FIG. 1 shows exemplary backup storage apparatus 10 comprising an exemplary tape library 10. The exemplary tape library 10 comprises a housing 11 in which a plurality of tape drives 12 (storage devices 12) are housed. A plurality of tape cartridges 13 (storage media 13) are loaded and stored in the housing 11 and which are manipulated by a robotics assembly 14 to load and unload them into a selected tape drive 12 to store data thereon or retrieve data therefrom. In other types of backup storage apparatus 10, the storage device 12 might comprise an optical disk reader used with optical disk media, or removable hard disk drives, for example.

An external management station 15 communicates with the tape library 10 by way of an external local area network (LAN) 16. The management station 15 is coupled by way of the external LAN 16 to a component 22 of the tape library 10 such as an interface manager 22 or management appliance 22. The interface manager 22 or management appliance 22 includes software tools 25 that aid in the configuration, installation, and management of the tape library 10, and specifically allow configuration and control of value added components 24 of the tape library 10. The interface manager 22 is coupled to an internal bus 18 comprising a communication link 18.

One or more interface controllers 21 may be coupled between selected tape drives 12 and the internal bus 18. The interface controllers 21 provide a communication path for the interface manager 22 to talk to the tape drives 12. The interface controllers 21 also provide a controlled data path between the tape drives 12 and a backup server 27. The backup server 27 communicates with the interface controllers 21 via a Fibre Channel fabric 26, shown in FIG. 1 as a storage area network (SAN) fabric 26, for example. A parallel data bus such as a Small Computer System Interface (SCSI) bus may be used in place of the Fibre Channel fabric 26, but this is not commonly used in current-generation computers.

The interface manager 22 or management appliance 22 and the interface controllers 21 comprise the value added components 24 of the tape library 10, i.e., components that may not be manufactured and installed by the original library manufacturer.

A library controller 17 is coupled by way of the internal bus 18 (communication link 18) to the one or more interface controllers 21 and to the interface manager 22 or management appliance 22. The library controller 17 is also coupled by the way of a private internal bus such as a PCI bus 19 to the robotics assembly 14.

The tape library 10 comprises an operator control panel and display system 30, referred to as an operator control panel 30 or OCP 30, which is preferably disposed on a front panel of the tape library 10, for ease of use. The operator control panel 30 controls local functions and displays information regarding the health of the tape library 10. The operator control panel 30 presents information about components in the tape library 10 that are built by the original library manufacturer.

The operator control panel 30 comprises a graphical user interface (GUI) 30a that displays library status information and allows a user to access the library menus. These menus allow a user to view or change the library settings, run demonstration programs, and run diagnostic tests, for example.

The operator control panel 30 may be coupled to the library controller 17, and is used to control functions of and display information regarding the tape library 10 in addition to components in the tape library 10 that are installed by the original library manufacturer. In particular the operator control panel 30 may be used to control functions of the interface manager 22 and display information known to it and to the interface controllers.

There is a communication link 31a between the tape library 10 and an interface connected to a supply ordering site 31, such as a supply ordering website 31, for example, through which supplies may be ordered.

The communication link 18 and information sharing protocol cooperate to register the library controller 17 with the interface manager 22. Once registered, the interface manager 22 and the library controller 17 communicate over the internal bus 18 using shared data objects having a shared format (i.e., a format shared by the interface manager 22 and library controller 17). The interface manager 22 and library controller 17 share their respective lists of objects corresponding to services that they provide. In this way, the interface manager 22 discovers services that are provided by the library controller 17 and vice-versa. The library controller 17 uses the shared data objects sent by the interface manager 22 to generate information that is to be displayed on the OCP 30. Furthermore, communication between the interface manager 22 and the library controller 17 via the information sharing protocol and communication link 18 allow the operator control panel 30 to control functions of the interface manager 22 and display information heretofore only available to the interface manager 22.

In general, the tape library 10 requires the use of specific tapes and barcodes. Hewlett-Packard Company (HP), for example, recommends that only HP tapes be used, and in many libraries 10 requires that the barcode are HP barcodes. The supplies are not always available at office supply stores and must be ordered from an approved supplier or directly from HP. This process involves a non-standard order for many customers that have standardized ordering processes and requires Internet ordering or telephone ordering. This is not a standard ordering practice for most customers and is inconvenient.

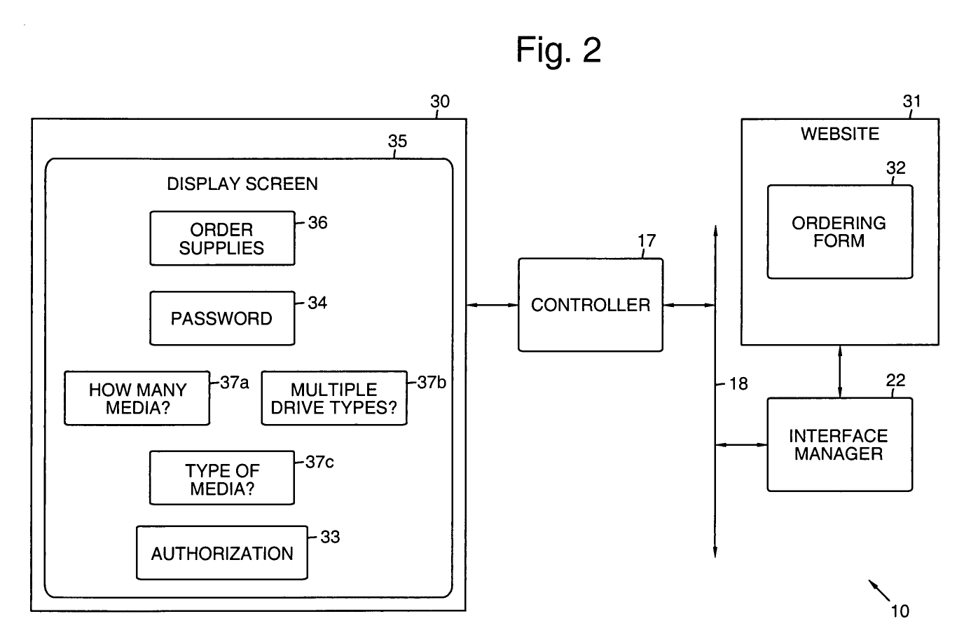

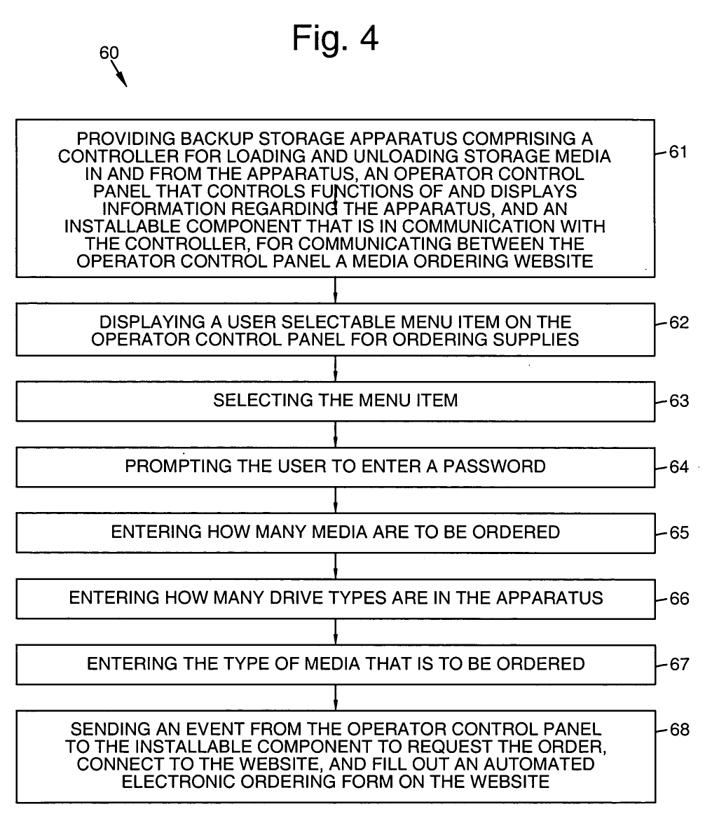

In order to remedy this, a media ordering process 50 or method 50 (FIG. 4) implemented using the operator control panel 30 is provided that makes it much easier for customers to order media 13. FIG. 2 generally illustrates how supplies are ordered from the operator control panel 30 using the media ordering process 50.

Information regarding what types of media 13 and barcodes that are needed is automatically input to an automated electronic ordering form 32 located at a supply ordering website 31, and a customer authorization code 33 or electronic signature 33 is added to the automated electronic ordering form 32 so that the media 13 can be ordered without giving the user broad purchasing powers.

The operator control panel 30 is configured to display an “Order Supplies” menu item 36 on its display 35 that is preferably in a password protected area, and which uses an “ADMIN” password 34 or “ORDER” password 34, for example, for access. When a user selects the “Order Supplies” menu item 36, a prompt is presented on the on display 35 asking for the password 34, how many 37a media 13 (tapes 13) are to be ordered, if there are multiple drive types 37b installed in the backup storage apparatus 10, and which type 37c of media 13 (tapes 13) is to be ordered. The interface manager 22 or management appliance 22 is sent an event requesting an order of “XX” media 13 (tapes 13). The interface manager 22 connects to the supply ordering website 31, such as a Hewlett-Packard Company website 31 (http://www.hp.com), and fills out the automated electronic ordering form 32 with the order information, indicating the order should be automatically shipped to the customer.

An interface may be implemented in the Command View software for the interface manager 22 that configures and enables the media ordering process 50. This interface requests input of required shipping and credit card information so that orders can be processed. The interface manager 22 may also request a list of email addresses to which order confirmation information is sent. This ensures that a manager or other administrative person always knows when supplies are ordered, in order to prevent abuse.

A predetermined location on the Hewlett-Packard Company supply ordering website 31, for example, stores various files for use by HP software tools that are available for use by customers. The interface manager 22 is programmed to look at the website 31 for a file that describes the current order information. If the ordering process 50 or part number of the media 13 that is ordered is changed, that file is updated with the new information so that an ordering code used by the interface manager 22 does not have to change.

This process 50 significantly reduces the amount of time it takes to order supplies, and increases the chances to get the order, since time is often an important issue for customers. Using authorized supplies for the backup storage apparatus 10 also ensures that the correct barcodes are used resulting in fewer warranty claims for problems relating to reading barcodes.

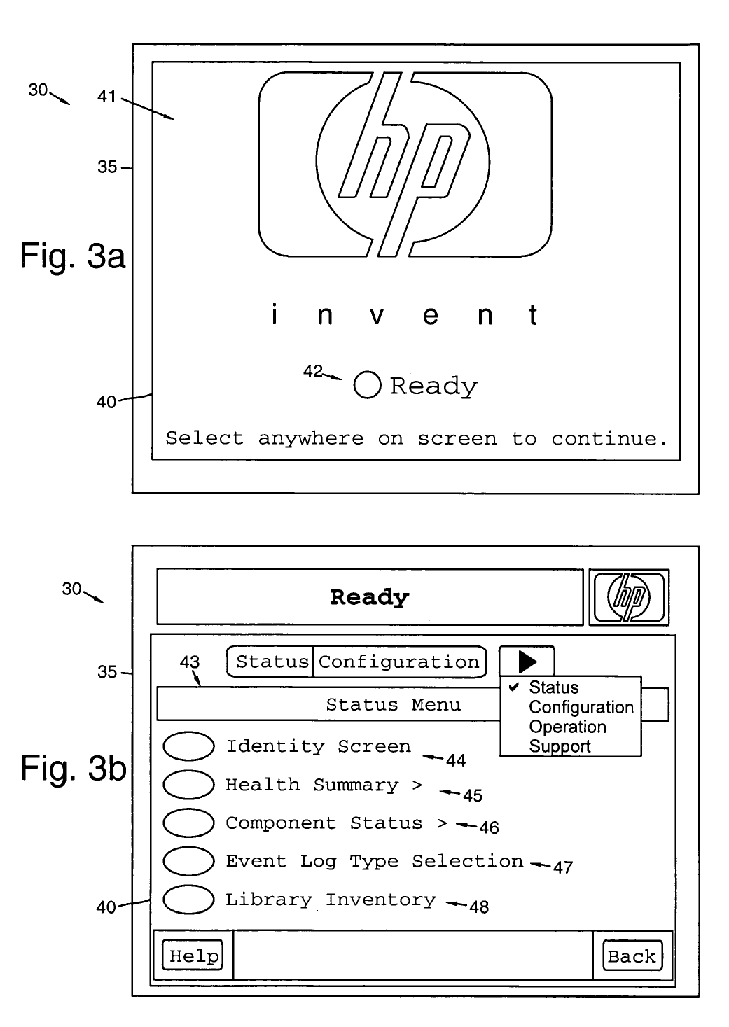

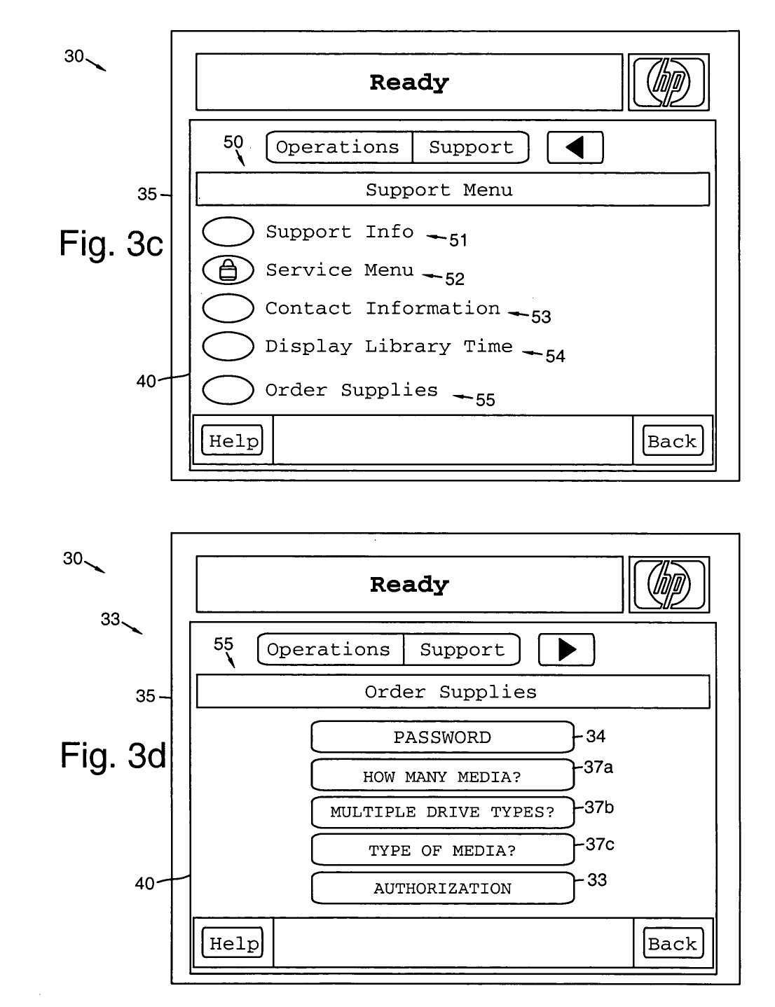

FIGS. 3a-3d illustrate exemplary display screens 40 that may be displayed on exemplary backup storage apparatus 10. FIGS. 3a-3c are exemplary display screens 34 through which a user may migrate so as to order media or supply for the backup storage device 10. FIG. 3d is a display screen 34 that may specifically be used to implement media ordering from a backup storage device 10, such as a tape library 10, for example. The exemplary screen displays 40 and media or supply ordering function 36 may be presented on a display screen 35 of the operator control panel 30. The operator control panel 30 is configured to provide easy and quick navigation to pertinent menu levels to arrive at a display screen that permits media ordering.

The exemplary media ordering function 36 may be implemented by way of a support menu 50 that is one menu of a menu structure or tree. The operator control panel 30 has a menu structure that has many paths, such as is illustrated by multiple menus shown in FIGS. 3a-3d, of which the support menu 50 is but one.

FIG. 3a shows an exemplary screen display 40 comprising an initial splash screen 41 showing a logo. Clicking on the screen display 40 takes the user of a subsequent screen display 40, shown in FIG. 3b.

The screen display 40 shown in FIG. 3b may be used to present Status, Configuration, Operation and Support information to the user. The user may display the information contained in the Status, Configuration, Operation and Support menus by clicking on the appropriate button at the top of the screen, or by clicking on the right pointing arrow to select one of the screens that is not yet displayed (Operation and Support screens, in this case).

A status menu 43 shown in FIG. 3b comprises icons 44-48, selectable text, or a banner, for example, that allows the user to access and display an identity screen 44, a health summary screen 45, a component status screen 46, an event log type selection screen 47, a library inventory screen 48, and other information that is not shown in FIG. 2b. Ellipses at the left side of the display screen 40 shown in FIG. 3b contain no icon, indicating that there are no problems. Status or warning icons may be displayed within the ellipses indicating that errors may be displayed by migrating to the particular screen display 40. Help and Back icons allow a user to access one or more help screens relating to what is displayed on the screen display 40, and to return to the previously displayed screen display 40.

FIG. 3c illustrates an exemplary Support menu 50, which is displayed by clicking on the Support button at the top of the screen shown in FIG. 3b, or by migrating to this screen using the right pointing arrow. The Support menu 50 shown in FIG. 3c allows the user to access support information 41, access a service menu 52, obtain contact information 53, display library time 54, and order supplies 55, for example.

FIG. 3d shows the a screen display 40 to access the supply ordering function 36. The “Order Supplies” icon 55 may be selected to order media. When the “Order Supplies” icon 55 is selected, the screen display 40 shown in FIG. 3d is presented. Performing the tasks shown in FIG. 3d causes generation and transmission of a media order to the supply ordering website 31.

The user enters a password 34, how many 37a media 13 (tapes 13) are to be ordered, if there are multiple drive types 37b installed in the backup storage apparatus 10, and which type 37c of media 13 (tapes 13) is to be ordered. The user enters an authorization code 33, and the order is transmitted. An event is sent to the interface manager 22 requesting the order. The interface manager 22 connects to the supply ordering website 31, and fills out the automated electronic ordering form 32 with the order information, indicating the order should be automatically shipped to the customer.

FIG. 4 is a flow diagram that illustrates details of an exemplary media ordering method 60 or algorithm 60 for use with the backup storage apparatus 10. The exemplary method 60 may be used with storage apparatus 10 such as magnetic tape libraries, optical drives and hard disk drives, for example. The exemplary method 60 comprises the following actions.

Backup storage apparatus 10 (such as a tape library 10) is provided 61 that comprises a controller 17 that controls and monitors a robotics assembly 14 that loads and unloads storage media 13 (such as tape cartridges 13) into and from at least one storage device 12, an operator control panel 30 coupled to the controller 17 for controlling functions of and displaying information regarding the backup storage apparatus 10, and an interface manager 22 coupled to the controller 17.

An “Order Supplies” menu item 36 is displayed 62 on the operator control panel 30, which may be in a password protected area. A user selects 63 the “Order Supplies” menu item 36. A password prompt is displayed 64 upon selection of the “Order Supplies” menu item 36, and the user enters a valid password.

The user enters 65 how many media 13 are to be ordered, enters 66 if there are multiple drive types 37b in the backup storage apparatus 10, and enters 67 the type(s) of media 13 that is (are) to be ordered.

An event is sent 68 to the interface manager 22 to request the order, request connection to an ordering website, and fill out an automated electronic ordering form 32 with the order information, requesting automatic shipment to the user.

It is to be understood that orders may be placed for things other than supplies. For example, a new Raid disc may be ordered using the above concepts if the array is filling up. New storage devices (tape drives) may be ordered if throughput is being challenged. A replacement robot may be ordered if the current one is near end-of-life. This list is illustrative, but not inclusive, of what may be ordered using the above-described principles.

Thus, storage apparatus 10 that utilizes storage supplies has been disclosed. Exemplary storage apparatus 10 comprises a housing 11, and a controller 17 contained within the housing 11 that is configured to robotically manage removable media 13. A communications module 22 is coupled to the controller 17 for communicating with a vendor. An operator control panel 30 is attached to the housing 11, is coupled to the controller 17, and is configurable to allow a user to order storage supplies from the vendor via the communications module 22, and whereby the storage supplies are ordered directly from the storage apparatus 10.

Thus, improved backup storage devices and methods that allow automatic ordering of supplies from an operator control panel have been disclosed. It is to be understood that the above-described embodiments are merely illustrative of some of the many specific embodiments that represent applications of the principles described herein. Clearly, numerous and other arrangements can be readily devised by those skilled in the art without departing from the scope of the invention.

What is claimed is:

1. Storage apparatus utilizing storage supplies, comprising:
a housing;
a controller contained within the housing and configured to robotically manage removable media;
a communications module coupled to the controller for communicating with a vendor; and
an operator control panel attached to the housing, coupled to the controller, and configurable to allow a user to order storage supplies from the vendor via the communications module, whereby the storage supplies are ordered directly from the storage apparatus.

2. The apparatus recited in claim 1 wherein the operator control panel is configurable to allow a user to enter how many media are to be ordered, send an event to the communications module to request the order, and cause the communications module to connect to a vendor website and fill out an automated electronic ordering form.

3. The apparatus recited in claim 1 wherein the operator control panel is configurable to cause the communications module to request automatic shipment of an order to the user.

4. The apparatus recited in claim 1 wherein the operator control panel is configurable to prompt the user to enter how many drive types are in the apparatus, and enter the type of media that is to be ordered.

5. The apparatus recited in claim 1 wherein the operator control panel is configurable to prompt the user to enter a password.

6. Storage apparatus utilizing storage supplies:
a housing;
controller means contained within the housing and configured to robotically manage removable media;
communications means coupled to the controller means for communicating with a vendor; and
operator control panel means attached to the housing, coupled to the controller means, and configurable to allow a user to order storage supplies from the vendor via the communications means, whereby the storage supplies are ordered directly from the storage apparatus.

7. The apparatus recited in claim 6 wherein the operator control panel means is configurable to allow a user to enter how many media are to be ordered, send an event to the communications means to request the order, and cause the communications means to connect to a vendor website and fill out an automated electronic ordering form.

8. The apparatus recited in claim 6 wherein the operator control panel means is configurable to cause the communications means to request automatic shipment of an order to the user.

9. The apparatus recited in claim 6 wherein the operator control panel means is configurable to prompt the user to enter how many drive types are in the apparatus, and enter the type of media that is to be ordered.

10. The apparatus recited in claim 6 wherein the operator control panel means is configurable to prompt the user to enter a password.

11. A media ordering method for use with storage apparatus, comprising:
providing storage apparatus comprising a housing, a controller contained within the housing and configured to robotically manage removable media, a communications module coupled to the controller for communicating with a vendor, and an operator control panel attached to the housing and coupled to the controller;
configuring the operator control panel to allow a user to order storage supplies from the vendor via the communications module;
displaying a user interface on the operator control panel for ordering supplies; and
ordering storage supplies directly from the storage apparatus.

12. The method recited in claim 11 further comprising configuring the operator control panel to allow a user to enter how many media are to be ordered, send an event to the communications module to request the order, and cause the communications module to connect to a vendor website and fill out an automated electronic ordering form.

13. The method recited in claim 11 further comprising configuring the operator control panel to cause the communications module to request automatic shipment of an order to the user.

14. The method recited in claim 11 further comprising configuring the operator control panel is configurable to prompt the user to enter how many drive types are in the apparatus, and enter the type of media that is to be ordered.

15. The method recited in claim 11 further comprising configuring the operator control panel to prompt the user to enter a password.
